(19) United States
(12) Patent Application Publication
(10) Pub. No.: US 2005/0249824 A1
(43) Pub. Date: Nov. 10, 2005

(54) Mold killer for homes and buildings

(76) Inventor: James A. Papp, Steamboat Springs, CO (US)

Correspondence Address: James A. Papp, P.O. Box 882191, Steamboat Springs, CO, 80488, US

(21) Appl. No.: 10/839,869

(22) Filed: May 7, 2004

(51) Int. Cl. A01N 25/00; A01N 59/06

(52) U.S. Cl. 424/696

(57) ABSTRACT

This invention provides a method for killing mold in existing homes and buildings or those under construction using Lime Sulfur in liquid or powder form.

This method of use invention kills mold in homes and buildings utilizing lime sulfur.

### BACKGROUND

The mold problem in homes and buildings exists in many regions of this country and throughout the world. In some instances the problem is epidemic and involves: insurance companies, homeowners, builders, architects, window and door providers, scientists, the legal profession and government agencies.

Mold is a fungus. There are over 200,000 different types, some of which are beneficial and others are harmful. Mold becomes a problem when mold spores germinate and an unchecked growth cycle begins. The elements needed for germination are water, oxygen, a food source and a temperature of approximately 55°-86°. The growth cycle of mold can cause destruction to the host such as wood and paper and can also trigger a serious health risk in humans and animals.

There are many theories on why the mold problem has reached such an epidemic outbreak in the last 10 to 15 years but they all include water. Water is needed for mold germination, and these are just some of the theories and factors involved that allow moisture to enter walls and buildings.
1. Bulk Water is the obvious result of incidents such as broken pipes, roof damage, poor construction or improper design or flashing.
2. Moisture Transference is a result of water being generated from within the home or building because of equipment, humidifiers, washers, showers and some heating systems. When this moisture is not diffused through normal movement and evaporation because of tighter structures, moisture may be trapped in the wall cavities. Modern more energy efficient building materials may be a factor in stopping the normal transference of moisture out of the home resulting in condensation inside the walls.
3. Construction does not occur in a controlled environment. The building materials may already have mold growing on them or they become wet which allows the mold spores to germinate.
4. There is a combination of factor three and factor two. Mold is built into the structure as previously stated and then moisture transference allows the growth cycle to continue.

The only solution for the mold problem now available is remediation. Remediation requires the removal of the mold, which requires the removal of the infected host. Remediation is costly, time consuming, doesn't always solve the problem and may or may not be covered by insurance.

There is a major problem for anyone with mold infestation. The average American views a home as a major asset. If the home has a mold problem it can quickly turn from an asset to a major liability. Without correcting the mold problem the home becomes unsaleable. Governments at all levels face a similar problem because they are involved in subsidized housing, military installations, schools, government buildings and Native American housing. The mold epidemic is a two fold problem: mold is destructive to the host and also it can be a major health problem as explained in Congressman John Conyers House Bill H.R. 5040 Toxic Mold Safety Protection Act.

### SUMMARY OF THE INVENTION

This method of use invention involves using lime sulfur, a recognized fungicide in agriculture, to kill mold in homes and other buildings. Lime sulfur can be used during construction to kill mold on construction materials and it can also be used on existing homes and buildings by injecting it into wall cavities and hard to access areas in foundations, floor and roof systems.

### BACKGROUND DESCRIPTION OF PRIOR ART

This invention relates to the killing of mold in homes and buildings.

Encyclopedia Americana Volume 12 2001 Pg. 169-180 acknowledges in an article by Jerry T. Walker of the University of Virginia that fungicides used in agriculture as early as 1800 were sulfur compounds. This article only mentions uses in agriculture not homes or buildings.

Random House Unabridged Dictionary Second Addition 1993 says the following: “Lime Sulfur Chemical. Mixture of lime and sulfur that is boiled in water, used in powdered form or aqueous solution as an insecticide, a fungicide and sheep dip.”

This description of uses mentions agriculture and also its uses on livestock not on homes or buildings.

Material Data Safety Sheet Best Sulfur Products, A Division of Formulators Inc. The M.D.S.S. lists lime sulfur solution as a chemical that combats powdery mildew; a fungus. This is significant because this product was used in our initial testing in June of 2003. Best Sulfur Products admitted that they had never thought of using their lime sulfur product to kill mold fungus in homes and buildings and they had not heard of anyone else using lime sulfur for that purpose.

U.S. Pat. No. 4,853,411.

This patent is for a biocide that represents, fluorine, chlorine or bromine in combination with a sulphone. This is used for the treatment of aqueous systems and does not mention homes or buildings.

### ADVANTAGES OF THIS INVENTION

1. There is a great need to find a practical solution for a problem that affects so many people and so much property.
2. Lime sulfur is a fungicide that has been thoroughly tested in agriculture. It has a M.D.S.S. and is safe enough to ship through the mail. The safety record for this product according to the E.P.A. is excellent and does not pose a threat to the environment when used properly.
3. This is a very cost effective method of solving the mold problem and it can be implemented immediately.
4. Lime sulfur can be used in the construction phase to kill mold on the building materials and it also can be used in a liquid or powder form to kill mold in existing homes and buildings.
5. If remediation is required in homes and buildings as a result of structural damage caused by mold; lime sulfur can be used to make sure any residual mold is killed.
6. Lime sulfur can be used in a repetitive manner to keep killing the mold if remediation can't take place immediately or if the problem of determining the cause of the water problem is not apparent.
7. Lime sulfur is a mold killer and can immediately eliminate the health hazard caused by germinating mold spores.

### CONCLUSION RAMIFICATIONS AND SCOPE

Lime sulfur is the only solution to the mold epidemic that can occur immediately and is cost effective. This problem is growing and is affecting more and more people everyday. In the last few years the insurance industry has added mold exclusion clauses or eliminated coverage altogether in homeowners policies. The legal profession is filing thousands of lawsuits every month. The scientific community is trying to get a better understanding of the molds that emit chemicals called mycotoxins to try and understand if they are a health risk.

Builders are being sued along with window and door manufactures, architects and anyone else in the construction industry or whose products are used in construction. In my research regarding lime sulfur, I contacted different entities involved with mold and the following people and organizations freely admitted they either never heard of lime sulfur or they never considered using it in homes or buildings.

This is the list of people I contacted concerning my idea of using lime sulfur on the mold problem:

| Suppliers: | | |
|---|---|---|
| Chemstar Lime - Mr. Curtis | | 1-800-288-9676 |
| Best Sulphur Products - Shawn Hallbrook | | 1-800-800-4854 |
| Universities: | | |
| University of Minnesota - | Marilou Cheple | 1-612-624-2767 |
| | Patrick Huelman | 1-612-624-1286 |

| University of Illinois | | 1-217-390-4137 |
|---|---|---|
| Building Research Institute - Bill Rose | | |
| Insurance Companies | | |
| Zurich | Steve Magnino V. P. Marketing | 1-847-605-6499 |
| | Steve Fritz V. P. Risk Engineer | 1-952-229-3606 |
| | Dave Czar Toryski, V. P. | 1-847-605-6638 |
| State Farm | Vince Trasino | 1-309-766-2311 |
| Insurance | Gail Montoure | |
| | Rosemary Macellvoy | |
| | Betsey Woodson | |
| Allstate Insurance | Bill Cox | 1-847-402-9329 |
| | Mark Magillvary | 1-847-402-3584 |
| | Donna Rosemyer | |
| | Dave Fox Holstein Insurance | 1-847-402-0822 |
| | (works for Allstate on mold) | |

| | |
|---|---|
| Government Agencies | |
| H.U.D. - Peter Ashley Healthy Homes | 1-800-569-4287 |
| EPA | 1-800-490-9194 |
| Agency for Toxic Substances | 1-800-422-8737 |
| National Association of Home Builders | |
| Tom Kenney | |
| Chaquita Ellis | 1-800-638-8556 |
| Congressman John Conyers | |
| HR 5040 Toxic Mold Safety Protection Act | 1-202-225-5126 |
| Legal Profession | |
| Sally Claassen P. C. | 1-970-879-8405 |
| Sandra Gardner P. C. | 1-970-870-8580 |
| Jocelyn Knoll P. C. | 1-612-338-0115 |
| Jack Sloan P. C. | 1-303-333-1470 |

Companies involved in remediation or interested in the mold problem:

| | |
|---|---|
| 3 M Corporatiion - Trish Soliday | 1-651-736-8084 |
| Scandia Stucco - Guy Wojtowicz | 1-612-919-5473 |
| Diamond Vogel Paint - Bob Harp | 1-712-737-4993 |
| Servpro - Hugh Lloyd | 1-615-451-0200 |

1. A lime sulfur composition suitable as a fungicide that can be applied to existing homes and buildings or homes and buildings under construction.
